(19) United States
(12) Patent Application Publication
(10) Pub. No.: US 2009/0099301 A1
(43) Pub. Date: Apr. 16, 2009

(54) MOLECULAR IMPRINTINGS FOR RECOGNITION IN AQUEOUS MEDIA, METHODS FOR PREPARING SAME AND USES THEREOF

(75) Inventors: Kaynoush Naraghi, Rouen (FR); Sami Bayoudh, Rouen (FR); Michel Arotcarena, Rouen (FR)

Correspondence Address: OLIFF & BERRIDGE, PLC, P.O. BOX 320850, ALEXANDRIA, VA, 22320-4850, US

(73) Assignee: POLYINTELL, Rouen (FR)

(21) Appl. No.: 12/282,623

(22) PCT Filed: Mar. 22, 2007
(86) PCT No.: PCT/FR07/50988

§ 371 Date: Nov. 7, 2008

(30) Foreign Application Priority Data
Mar. 22, 2006 (FR) 0650992

(51) Int. Cl. C08L 67/04; C08G 65/26; C08G 69/02; C08G 69/24; C08G 75/24; C08L 77/02; C08L 67/06; C08G 63/00; C08G 63/08; C08L 53/00

(52) U.S. Cl. 524/600; 528/393; 527/313; 527/201; 528/392; 528/330; 528/367; 528/381; 528/271; 528/361; 525/92 R; 524/599; 525/529; 525/421; 525/451; 977/754

(57) ABSTRACT

The present invention relates to crosslinked polymeric nanospheres having a star-shaped structure of the core-branch type, in which the branches are of a hydrophilic nature and the core is of a polymeric, crosslinked, hydrophobic nature and forms the imprint of all or at least part of a target molecule and to a process for preparing them.

The present invention relates to the field of molecular imprintings useful for the recognition of target molecules.

The present invention relates in particular to molecular imprintings in the form of crosslinked polymeric nanospheres of the core-branch type and more particularly formed of a hydrophobic core and of branches of a hydrophilic nature.

The present invention also relates to the nanogels and hydrogels formed from such polymeric nanospheres, and to their uses.

Molecular imprinting materials, also called MIPs, are obtained by a molecular imprinting technique.

In general, these molecular imprintings are obtained by copolymerizing monomers of crosslinking agent(s) in the presence of a molecule whose imprint it is sought to fix precisely. The monomers become arranged specifically around this molecule, also called “master molecule”, by strong or weak interactions, and are generally polymerized in the presence of a high level of crosslinking agent. After polymerization, the molecule is extracted from the polymer material and thus leaves its molecular imprint in cavities within the material. These cavities are real synthetic receptors comparable to antibody-type biological receptors. Molecular imprinting materials of the artificial antibody type have been used in chromatographic separation applications, sensors, chemical reaction catalysis, solid phase extraction, immunoanalysis, screening of molecular libraries and the like.

More precisely, there are two possible approaches for making molecular imprints, the covalent approach developed by Wulff in the document U.S. Pat. No. 4,127,730 and the noncovalent approach developed by Mosbach in the document U.S. Pat. No. 5,110,833.

In the covalent approach, the interactions between the monomers and the master molecule are of the labile covalent bond type. In this case, after extraction of the master molecule by breaking of the covalent bond, the recognition of the target molecules is also performed by the formation of a covalent bond between the imprint and the target molecule considered.

In the noncovalent approach by Mosbach, the interactions between the monomers and the master molecule are weak bonds of the hydrogen bond, ionic bond, pi donor-pi acceptor, Van Der Waals bond or hydrophobic interaction type. After extraction of the master molecule, the recognition of target molecules is also performed by noncovalent interactions between the imprint and the target molecule.

The two approaches may be combined using the first approach of the covalent type for the preparation of the molecular imprinting material and the second approach in order to obtain a recognition by noncovalent interactions, as is for example disclosed in M. J. WHITCOMBE et al. “A New Method for the Introduction of Recognition Site Functionality into Polymers prepared by molecular Imprinting: Synthesis and Characterization of Polymeric Receptors for Cholesterol” J. Am. Chem. Soc., 1995, 117, 7105-7111.

This imprinting technique has shown its efficacy when the imprinting is performed in aprotic organic solvents but, on the other hand, has shown weaknesses and limitations when the imprinting is performed in polar protic solvents (water, alcohols).

Attempts have been made in order to increase recognition, especially of hydrophilic molecules such as sugars, in water or in polar protic solvents, using interactions of the metal coordination type (Striegler et al. “Evaluation of new strategies to prepare templated polymers with sufficient oligosacharide recognition capacity”, Analytica Chimica Acta 484, 2003, 53-62) without however being entirely satisfactory.

Also in the context of the development of imprints useful for recognition in water, very hydrophilic matrices have been prepared for riboflavin and its derivatives in the document WO 2004/067578, or for D-glucose in E.Oral et al. “Dynamic Studies of Molecular Imprinting Polymerizations”, Polymer 45, 2004, 6163-6173.

Conventionally, molecular imprints are synthesized in the form of a monolith, by solubilizing all the compounds in a solvent which also acts as a porogen. The gels thus formed must then be ground and sieved before use.

To dispense with these grinding and sieving steps, methods based on polymerization in dispersed medium, and in particular in the form of an oil-in-water emulsion, have moreover been developed.

Among the polymerization techniques in dispersed medium, some methods of precipitation using soluble monomers in the continuous phase do not require the use of a surfactant (Lei Ye et al., Analytica Chimica Acta 435, 2001, 187-196). This type of method indeed makes it possible to obtain uniform microspheres with a good yield, but is on the other hand limited by the dispersion of the master molecule in the whole mixture.

In fact, most of the methods by polymerization in dispersed medium generally require the use of a surfactant because the monomers are not soluble in the continuous phase. Thus, examples of polymerization in suspension using a conventional surfactant and an aqueous continuous phase (J. Matsui et al., Anal. Commun. 34, 1997, 85) or a perfluorinated continuous phase (A.G. Mayes et al, Anal. Chem. 68, 1996, 3769) are already well known. In the document US 2003/139483, it is moreover proposed to use a surfactant bearing the master molecule at one of its ends.

There may also be mentioned the case of seed polymerization (K. Hosoya et al. in: R. A. Bartsch, M. Maeda (Eds.), “Molecular and Ionic recognition With Imprinted Polymers”, American Chemical Society, Washington, D.C., 1998, p. 143), mini-emulsion polymerization (D Vaihinger et al, Macromol. Chem. Phys. 2002, 203, 1965-1973), core-shell polymerization (N. Perez et al., J Appl. Polym. Sci 2000, 77, 1851-1859) or UV photopolymerization (M. B. Mellott et al., Biomaterials 22, 2001, 929-941). The surfactants used according to these methods are absorbed on the surface of the polymeric particles by physical intermolecular interactions leading to the formation of micelles and to the reduction of the interfacial tension of the polymeric particles and therefore to their stabilization.

However, the dispersion obtained according to these processes is not always stable because the absorption-desorption equilibrium of the surfactants between the surface of the particles and the continuous phase may be displaced following a variation of certain parameters such as pH or temperature, resulting, depending on the cases, in the precipitation of the polymeric particles.

It is known, from Koide et al., to use a monomer functionalized at one of its ends by a carboxyl functional group and at the other by a vinyl functional group for the synthesis, in water, of divinylbenzene resins which complex metal ions (Y. Koide et al, Bull. Chem. Soc. Jpn. 1996, 69, 125). The acid functional group of the monomer allows the complexing of the metal at the surface of the resin and the hydrophobic character of the monomer allows this functional group to be maintained at the surface.

Other authors synthesize soluble microgels which are crosslinked polymers in solution having sufficiently small sizes to remain in solution despite the absence of surfactants (Maddock et al. Chem. Commun. Novel imprinted soluble microgels with hydrolytic catalytic activity, 2004, 536- 537) (Biffis et al., Macromol. Chem. Phys. The Synthesis, Characterization and Molecular Recognition Properties of Imprinted Microgels 2001, 202, 163-171). These microgels are synthesized in organic solvents such as dimethyl sulfoxide or ketones. This option therefore turns out to be appropriate only for the preparation of very small sized polymeric particles.

A need therefore remains for a method which makes it possible to effectively and durably stabilize polymeric particles obtained by polymerization in dispersed medium, and which is free of the abovementioned disadvantages.

The aim of the present invention is precisely to provide a novel polymerization method, useful for the synthesis of molecular imprinting materials appropriate for recognition in aqueous medium, and in conformity with the abovementioned requirements.

Thus, according to a first of its aspects, the present invention relates to crosslinked polymeric nanospheres having a star-shaped structure of the core-branch type, in which the branches are of a hydrophilic nature and the core is of a polymeric, crosslinked, hydrophobic nature and forms the imprint of all or at least part of a target molecule.

According to another of its aspects, the invention relates to a process for preparing polymeric nanospheres according to the invention by copolymerization, for example in dispersed medium, of at least one amphiphilic macromonomer with at least one hydrophobic monomer in the presence of at least one hydrophobic crosslinking agent and at least one master molecule, followed by the extraction of said master molecule from said nanospheres thus formed, for example by washing.

Unexpectedly, the inventors have thus observed that the use of an amphiphilic macromolecule, that is to say possessing at least one motif in particular a hydrophilic segment and at least one polymerizable hydrophobic motif, allows the synthesis of amphiphilic polymeric nanospheres comprising hydrophilic segments covalently linked at the surface of a hydrophobic core.

Thus, according to a particular embodiment, the invention also relates to crosslinked polymeric nanospheres having a star-shaped structure of the core-branch type in which the branches are of a hydrophilic nature and respectively formed by the hydrophilic segment of at least one amphiphilic macromolecule, in particular as defined above, and the core is of a polymeric, crosslinked, hydrophobic nature, forms the imprint of all or part of a target molecule, and is derived from copolymerization, in particular free-radical copolymerization, of the hydrophobic polymerizable motif of said amphiphilic macromonomer with at least one hydrophobic monomer in the presence of at least one hydrophobic crosslinking agent and a master molecule.

According to another of its aspects, the invention also relates to a process for preparing polymeric nanospheres according to the invention, comprising:
a first step of copolymerizing at least one functionalized hydrophobic monomer in the presence of at least one hydrophobic crosslinking agent, at least one master molecule, and optionally at least one hydrophobic monomer, in particular as defined below,
a second step of converting, at the surface, the hydrophobic and crosslinked polymeric entity obtained at the end of the first step with one or more hydrophilic entities,
and extracting said master molecule from said polymeric nanospheres thus formed, for example by washing.

The nanospheres according to the invention prove to be particularly advantageous in the light of their amphiphilic behavior, linked to the concomitant presence, within their structure, of a hydrophobic core, and of hydrophilic branches covalently grafted to said core, and soluble in aqueous media. Such an organization allows their dispersion and their stabilization in aqueous medium by steric repulsion between the hydrophilic branches.

Such a structure is also particularly advantageous since it ensures increased stabilization of the dispersion of the nanospheres thus obtained, in particular on a wide range of operating conditions, for example in terms of polarity of the solvent and of pH variations.

Moreover, when the polymeric nanospheres according to the invention are packaged in powdered form, they also have the advantage of being able to be easily prepared as a stable solution, without adding surfactants.

Another advantage of the polymeric nanospheres according to the invention is the stabilization, in polar and protic media such as water and alcohols, of the molecular imprints formed in their hydrophobic core. The recognition of target molecules in these media is consequently more efficient therein.

The polymeric nanospheres according to the invention are also useful for forming nanogels and hydrogels.

Thus, according to another of its aspects, the invention relates to a nanogel which is in the form of a dispersion of polymeric nanospheres in accordance with the invention.

Such a nanogel may in particular be obtained directly at the end of the methods of preparing the polymeric nanospheres according to the invention proposed above.

The invention therefore also relates in particular to a process for preparing a nanogel of polymeric nanospheres according to the invention comprising at least the copolymerization, for example in dispersed medium, of at least one amphiphilic macromonomer comprising a single hydrophobic motif capable of copolymerizing with at least one hydrophobic monomer in the presence of at least one hydrophobic crosslinking agent and at least one master molecule, and the extraction of said master molecule from said polymeric nanospheres thus formed, for example by washing.

According to another of its aspects, the invention relates to a hydrogel which is in the form of a network of polymeric nanospheres in accordance with the invention.

The invention also relates to a process for preparing a hydrogel of polymeric nanospheres according to the invention comprising at least the copolymerization, for example in dispersed medium, of at least one amphiphilic macromonomer comprising at least two hydrophobic units capable of copolymerizing with at least one hydrophobic monomer in the presence of at least one hydrophobic crosslinking agent and at least one master molecule, and the extraction of said master molecule from said polymeric nanospheres thus formed, for example by washing.

The subject of the present invention is also the use of the polymeric nanospheres, the nanogels and the hydrogels according to the invention for the purpose of extraction, detection, separation, purification, absorption, adsorption, retention or controlled release or in applications chosen from sensors, catalysis of chemical reactions, screening of molecules, directed chemical synthesis, treatment of samples, combinatory chemistry, chiral separation, group protection, displacement of equilibrium, polymeric medicaments and encapsulation.

The polymeric nanospheres according to the invention, in particular organized in the state of a nanogel and/or hydrogel, the nanogels according to the invention and the hydrogels according to the invention are found to be particularly useful for the selective isolation, in their hydrophobic core, of sensitive target molecules in aqueous media or in complex biological fluids, such as for example certain metabolites or molecules which can be degraded by enzymes.

As another application of polymeric nanospheres according to the invention, nanogels according to the invention and hydrogels according to the invention, there may also be mentioned the recognition and extraction of hydrophobic or amphiphilic target molecules in organic medium. Most of the macromonomers which can be used in the present invention are indeed also soluble in organic solvents, thus allowing polymeric nanospheres, and therefore the molecular imprinting materials according to the invention, to be maintained in solution.

### DEFINITION

In the context of the present invention, the expression “target molecule” is meant to denote any entity capable of specifically binding to the molecular imprint, and the expression “master molecule” is meant to denote any molecule which may be used as master for the preparation of the molecular imprint.

The master molecule may be similar to the target molecule, and in particular of similar molecular size. The target molecules and the master molecules considered in the present invention are more particularly hydrophobic or amphiphilic.

Thus, according to one embodiment of the invention, the imprint formed in the core of the polymeric nanospheres according to the invention is that of a hydrophobic or amphiphilic molecule.

According to one variant, the master molecule is identical to the target molecule.

According to another variant, the master molecule is different from the target molecule but is such that it forms a molecular imprint having at least one recognition site for at least one target molecule.

The expression “recognition site” is meant to denote the site of the matrix of the molecular imprint which is effectively involved in the recognition of the molecular target(s).

The expression interaction between the master molecule or the target molecule and a recognition site is understood to mean, for the purposes of the invention, the formation of weak bonds (for example of the Van der Waals bond, hydrogen bond, pi donor-pi accepteur bond or hydrophobic interaction type) and/or of strong bonds (for example of the ionic bond, covalent bond, iono-covalent bond or dative bond type, or of the coordination bond type).

The expression “hydrophilic nature” is understood to mean a capacity to be solubilized in water. A hydrophilic compound or segment may for example bear functional groups capable of forming hydrogen bonds with water molecules, such as for example hydroxyl, amine, amide or carboxylic acid functional groups.

In the context of the present invention, an entity is said to have a “hydrophilic” nature when it has a log P in water, at 25° C., of less than or equal to 0.

Log P is a parameter commonly used to estimate the hydrophilicity (respectively hydrophobicity) of a chemical compound.

It is based on the partition coefficient P, defined as the ratio of the concentration of said compound in the form of a neutral molecule in a given lipophilic phase, called partition solvent, to the concentration of this same compound in an aqueous phase, in a biphasic mixture consisting of the partition solvent and the aqueous phase, at a given temperature and pH.

The partition solvent conventionally used to evaluate the partition coefficient is octanol. It is sometimes possible to select an organic solvent having a different behavior, such as for example cyclohexane, chloroform or propylene glycol dipelargonate.

In the present application, the log P values indicated are calculated by modeling or measured using octanol as partition solvent, at a temperature of 25° C. and a pH such that the compound is in the form of a neutral molecule.

The log P values may be calculated in particular in a theoretical manner by software packages for computer chemistry, such as for example the software Advanced Chemistry Development (ACD/Labs) V8.14.

In the context of the present invention, an entity is said to have a “hydrophobic nature” when it has a log P in water, at 25° C., greater than or equal to 0.

By way of example of hydrophobic monomers for the purposes of the invention, there may be mentioned in particular 3-phenoxy-2-hydroxypropyl acrylate (log P=1.978±0.295), 2-vinylpyridine (log P=1.338±0.264), 2-carboxyethyl methacrylate (log P=1.152±0.279), styrene (log P=2.700±0.191), methacrylic acid (log P=0.831±0.269), methyl methacrylate (log P=1.346±0,250) or 2-(dimethylamino)-ethyl acrylate (log P=0.948±0.276), the log P values indicated being those calculated by the software Advanced Chemistry Development (ACD/Labs) V8.14.

By way of hydrophobic crosslinking agents for the purposes of the invention, there may be mentioned in particular ethylene glycol dimethacrylate (log P=2,783±0.342), divinylbenzene (log P=3.181±0.209) or trimethylolpropane trimethacrylate (log P=3.154±0.453), the log P values indicated being those calculated by the software Advanced Chemistry Development (ACD/Labs) V8.14.

In the context of the present invention, a so-called “amphiphilic” entity has at least one hydrophobic motif and at least one hydrophilic segment.

For the purposes of the present invention, the expression “polymer” is meant to denote a product derived from the polymerization or copolymerization of at least monomers and characterized by certain properties such as molecular mass.

For the purposes of the present invention, the term “monomer” covers a molecule capable of being converted to a polymer by combination with itself or with other molecules of the same time, such as for example a macromonomer.

For the purposes of the present invention, the expression “macromonomer” is meant to denote a polymeric macromolecule capable of copolymerizing, consisting, at least one of its ends, of a polymerizable motif allowing it to react as a monomer, onto which a linear or branched pendent macromolecule is covalently grafted.

### POLYMERIC NANOSPHERES

The polymeric nanospheres according to the invention are substantially spherical particles of a polymeric nature, having a size varying from 1 nm to 10 micron approximately, preferably from 1 nm to 1 micron approximately, or even from 5 to 500 nm. The mean size in numerical terms of the particles according to the invention may be evaluated by light scattering.

As specified above, the polymeric nanospheres according to the invention possess a star-shaped structure of the “core-branch” type, this three-dimensional architecture being formed of an entity of a crosslinked and hydrophobic polymeric nature, the “core”, and of hydrophilic segments covalently linked to the outer surface of the core, called “branches”.

The branches are therefore covalently linked to the core.

The branches of a hydrophilic nature may for example have a molecular weight varying from 300 to 300 000 g/mol and preferably from 500 g/mol to 50 000 g/mol.

The branches of a hydrophilic nature may comprise hydrophilic segments chosen from segments of the polyoxyethylene (POE), polysaccharide, polyoxyethylene-polyoxypropylene-polyoxyethylene (POE-PPO-POE), polyoxypropylene-polyoxyethylene-polyoxypropylene (PPO-POE-PPO), polyvinyl alcohol, polydioxalane, poly(N-isopropylacrylamide) (poly(NIPAM)), polyethyleneimine, polyzwitterion, poly(meth)acrylamide, poly(aminoalkyl(meth)acrylate), polyvinylpyrrolidone, polypropylene glycol, polynucleotide, polypeptide and polyelectrolyte such as polysulfonic, polycarboxylic and polyphosphate type and their hydrophilic copolymers.

According to one variant embodiment, the branches may also comprise at least one segment having an LCST (Low Critical Solution Temperature), such as for example poly(NIPAM), in a sufficient quantity to be able to advantageously confer on the nanospheres integrating them a capacity to pass from a solid state to a liquid state, when the temperature reaches a certain critical value. This property may be particularly advantageous for isolating the nanospheres.

The branches may also additionally contain in their polymeric segment(s) one or more labile bonds which are capable of breaking under the action of temperature, a pH variation, an oxidoreduction reaction, an ultrasound beam or shearing.

According to a first embodiment, the nanospheres according to the invention may be used in an individualized form, that is to say without any bond being established between them. Such an organization involves in particular a deficiency of reactivity between the hydrophilic segments having the branches of the star-shaped structures. In particular, the nanospheres in accordance with the invention may exist in the form of a nanogel, and may for example be in dispersion in water.

According to a second embodiment, the nanospheres according to the invention may be organized in a network so as to form a hydrogel, in which for example the hydrophobic polymer cores which form the molecular imprints have crosslinking nodes of said hydrogel. In this type of organization, hydrophilic branches establish bonds between two distinct cores.

As regards this second variant embodiment, it may be advantageous for the hydrophilic branches to have a labile bond. Thus, the breaking of such labile bonds in the hydrophilic branches can cause the individualization of the nanospheres, initially organized in the form of a network and in particular of a hydrogel. The nanospheres according to the invention may then exist again in an individualized form in the dispersion in the continuous phase, and in particular in the state of a nanogel as described above.

### PROCESS FOR PREPARING NANOSPHERES

As specified above, the star-shaped structure of the core-branch type of the polymeric nanospheres according to the invention may, according to a first embodiment of the invention, be obtained by copolymerization of at least one amphiphilic macromonomer with at least one hydrophobic monomer in the presence of at least one hydrophobic crosslinking agent and at least one master molecule followed by the extraction of said master molecule from the nanospheres formed, for example by washing.

The polymerization may be performed by the free-radical or ionic route, by polycondensation, by coordination or by the sol-gel route.

The polymerization may be preferably carried out according to a dispersed phase polymerization technique, for example in an aqueous continuous phase.

This polymerization technique makes it possible to obtain particles having a size ranging from the nanometer to the micron, the size of the particles depending in particular on the relative quantities of dispersant and dispersed media and the mode of dispersion.

Quite obviously, the size of the polymeric nanospheres may be advantgeously adjusted by methods known to a person skilled in the art according to the size of the target molecule whose imprint it is desired to form.

Amphiphilic Macromonomers

The amphiphilic macromonomers which can be used according to the present invention are amphiphilic macromolecules in which at least one of the ends carries a polymerizable hydrophobic motif, or so-called hydrophobic motif capable of copolymerizing in the present invention.

The branches of the polymeric nanospheres in accordance with the invention may thus be formed of the hydrophilic segments of the macromonomers according to the invention.

The amphiphilic macromonomers considered according to the invention are found to be particularly advantageous compared to the nonionic surfactants. Thus, unlike the conventional surfactants, the hydrophilic segments of the macromonomers which ensure the stabilization of the polymeric nanospheres are covalently linked to the hydrophobic core forming the molecular imprint.

These macromonomers thus allow the formation of micelles in aqueous medium via their hydrophilic segments which are soluble in water while their hydrophobic polymerizable motif participates in the formation of the core of the nanosphere to be stabilized.

The macromonomers which can be used in the present invention preferably have a weight average molecular mass ranging from 300 to 300 000 g/mol, in particular ranging from 500 to 50 000 g/mol.

The hydrophilic segments of the macromonomers which can be used in the present invention correspond to the definition proposed for the hydrophilic branches described above.

Thus, they may be in particular of the polyoxyethylene (POE), polysaccbaride, polyoxyethylene-polyoxypropylene-polyoxyethylene (POE-PPO-POE), polyoxypropylene-polyoxyethylene-polyoxypropylene (PPO-POE-PPO), polyvinyl alcohol, polydioxalane, poly(N-isopropylacrylamide) (poly(NIPAM)), ethyleneimine, polyzwitterion, poly(meth)acrylamide, poly(aminoalkyl(meth)acrylate), polyvinylpyrrolidone, polypropylene glycol, polynucleotide, polypeptide and polyelectrolyte such as polysulfonic, polycarboxylic and polyphosphate type and their hydrophilic copolymers or any other water-soluble polymer modified with one or more polymerizable hydrophobic functional groups.

As hydrophobic motif capable of copolymerizing which may be present in a macromonomer according to the present invention, there may be mentioned in particular the vinyl, acrylic, methacrylic, allyl, styrene motifs or any other unsaturated motif capable of reacting by the free-radical route, and the chemical groups allowing a polycondensation or sol-gel reaction.

It is understood that the amphiphilic macromonomer may comprise, in addition to at least one hydrophilic segment and at least one hydrophobic polymerizable motif, other segments provided that they do not affect its amphiphilic nature necessary for the formation of the star structure of the nanospheres derived from its copolymerization. Thus, the amphiphilic macromonomer suitable for carrying out this embodiment of the invention may also comprise, in addition to the polymerizable motif described above, a hydrophobic segment adjacent to said polymerizable motif and of the polystyrene, polyalkyl, polyaryl, poly(methylstyrene), polyurethane, polyvinyl chloride, polyimide, polyvinyl acetate, polyester, polyoxypropylene, poly(meth)acrylic ester or polyamide type, it being understood that the hydrophilic segments of the macromonomer make it possible to confer on the corresponding branches the required properties according to the invention.

According to a first variant, at least one amphiphilic macromonomer which can be used for carrying out the present invention, and in particular which can be used for the synthesis of polymeric nanospheres according to the invention, may have a single hydrophobic motif capable of copolymerizing, present for example at one end of the hydrophilic segment. The polymeric nanospheres then obtained exist in an individualized form, for example in the form of a nanogel.

By way of example of amphiphilic macromonomers having a single polymerizable motif which can be used in the present invention, there may be mentioned in particular polyethylene glycol ethyl ether methacrylate, polyethylene glycol (meth)acrylate, polyethylene glycol methyl ether-block-polylactide, polyethylene glycol alkyl ether (meth)acrylate, polyethylene glycol aryl ether (meth)acrylate, polyethylene glycol vinylbenzene, block copolymers containing a hydrophilic segment and a polymerizable hydrophobic motif such as polyacrylic acid-block-polystyryl styrene, polyacrylamide-block-polystyryl styrene, polysaccharide-block-polymethacryloyl (meth)acrylate, and any triblock copolymer containing a hydrophobic segment, a hydrophilic segment and a single polymerizable hydrophobic unit.

The preferred amphiphilic macromonomers having a single polymerizable motif in this variant embodiment of the invention are polyethylene glycol (meth)acrylate and polyethylene glycol alkyl ether (meth)acrylate.

According to a second variant, at least one amphiphilic macromonomer which can be used for carrying out the present invention, and in particular which can be used for the synthesis of the polymeric nanospheres according to the invention, may have at least two hydrophobic motifs capable of copolymerizing, for example attached to each of the ends of a hydrophilic segment.

The polymeric nanospheres are then obtained in a form organized into a network so as to form a hydrogel in which the hydrophobic cores in which the molecular imprints are formed have crosslinking nodes and the hydrophilic segments establish covalent linkages between two separate cores.

By way of example of amphiphilic macromonomers having at least two polymerizable motifs which can be used in the present invention, there may be mentioned in particular polyethylene glycol di(meth)acrylate, polyethylene glycol divinylbenzene, or tiblock copolymers consisting of a hydrophilic central block (for example based on polyethylene glycol, polyacrylic acid, polyacrylamide, poly(vinylpyrrolidone), or polysaccharide and of a hydrophobic block modified by a polymerizable functional group at each end (for example of the polystyryl styrene or polymethacryloyl (meth)acrylate type).

The preferred amphiphilic macromonomers having at least two polymerizable units in this variant embodiment of the invention are polyethylene glycol diacrylate and polyethylene glycol dimethacrylate.

It is understood that the synthesis of a macromonomer suitable for carrying out the invention is within the competence of persons skilled in the art.

According to this variant, at least one amphiphilic macromonomer having a single hydrophobic unit capable of copolymerizing, for example as described above, may additionally be copolymerized during the synthesis of the polymeric nanospheres.

In other words, the polymeric nanospheres according to the invention may result in particular from the copolymerization of at least one amphiphilic macromonomer having a single polymerizable motif and at least one amphiphilic macromonomer having at least two polymerizable motifs.

That is the case in particular for the polymeric nanospheres existing in a form organized in a network so as to form a hydrogel.

The hydrophilic segments of the amphiphilic macromonomers having a single polymerizable motif may then be advantageously useful for stabilizing the nanospheres.

This stabilization thus advantageously makes it possible to dispense with the need to use other stabilization systems, such as for example surfactants.

Moreover, the addition of these amphiphilic macromonomers having a single polymerizable motif also makes it possible to act on the physical properties of the gel such as the elasticity.

Thus, the content of amphiphilic macromonomers having a single polymerizable motif compared with the amphiphilic macromonomers having at least two polymerizable motifs is optimized according to the physical properties of the hydrogel and the properties of the nanospheres desired.

These amphiphilic macromonomers having a single polymerizable motif may in particular be present in an amount of between 0 and 50% by weight relative to the total weight as amphiphilic macromonomers having at least two polymerizable motifs.

As specified above, the amphiphilic macromonomer considered is copolymerized with at least one hydrophobic monomer in the presence of at least one hydrophobic crosslinking agent, and at least one master molecule.

The hydrophobic monomers suitable for carrying out the present invention also advantageously have affinities with the master molecule whose imprint it is desired to make.

They may be chosen for example from acrylic, methacrylic, acrylamide, styrene, vinyl and allyl monomers or any other unsaturated monomer, and chemical groups allowing a polycondensation or sol-gel reaction.

The hydrophobic monomers suitable for carrying out the present invention have a log P greater than 0, and preferably greater than 0.5, or even greater than 1.

By way of example of hydrophobic monomers which can be used in the context of the present invention, there may be mentioned in particular methyl methacrylate, styrene, ethylstyrene, methacrylic acid, alkyl methacrylates, alkyl acrylates, allyl acrylates, allyl methacrylates, aryl acrylates, aryl methacrylates, styrene derivatives, vinyl acetate, acrylonitrile, methacrylonitrile, 2-aminoethyl methacrylate, t-amyl methacrylate, 2-(1-aziridinyl)ethyl methacrylate, t-butylacrylamide, butyl acrylate, butyl methacrylate, 4-vinylpyridine, 2-vinylpyridine, 2-vinylquinoline, dimethylaminoethyl acrylate, 3-phenoxy-2-hydroxypropyl acrylate and 2-carboxyethyl methacrylate.

According to a particular embodiment, the nanospheres result from the copolymerization of at least one polyethylene glycol methacrylate macromonomer and of at least one monomer of the (meth)acrylate type.

According to a particular embodiment, a hydrophobic monomer capable of copolymerizing with the amphiphilic macromonomer may be additionally covalently linked to the target molecule, or to the master molecule by a labile bond of the ester, disulfide, amide, boronic ester, ketal, hemiketal, carbamate, silyl, ether, thioester or thioether type. After synthesis of the nanosphere and formation of the molecular imprint, this bond may be broken by a variation of pH, an oxidoreduction reaction or by a reaction with a Lewis acid or base, thereby leading to the release and removal of the master molecule.

According to another embodiment, the nanospheres result from the copolymerization of at least one macromonomer, at least one monomer and at least one crosslinking agent having a log P greater than 0 in the presence of a master molecule having a log P greater than 0, in a fatty phase dispersed in an aqueous solution.

According to another embodiment, the nanospheres result from the copolymerization of at least one macromonomer, and at least one monomer having a log P greater than 0.5 and at least one crosslinking agent having a log P greater than 0.75 in the presence of a master molecule having a log P greater than 0, in a fatty phase dispersed in an aqueous solution.

According to another embodiment, the nanospheres result from the copolymerization of at least one macromonomer, at least one monomer and at least one crosslinking agent having a log P greater than 1 in the presence of a master molecule having a log P greater than 0 in a fatty phase dispersed in an aqueous solution.

The star structure of the core-branch type characterizing the polymeric nanospheres according to the invention may also be obtained by other routes of synthesis than that presented above.

For example, this synthesis may be carried in two successive stages, the first stage being intended for the formation of a hydrophobic and crosslinked polymeric entity forming the molecular imprint of a master molecule, and the second step for the surface conversion of this entity with entities of a hydrophilic nature.

Thus, according to another of its aspects, the invention relates to a process for preparing polymeric nanospheres according to the invention, comprising:
a first step of copolymerizing at least one functionalized hydrophobic monomer in the presence of at least one hydrophobic crosslinking agent, at least one master molecule and optionally at least one hydrophobic monomer as described above,
a second step of surface conversion of the hydrophobic and crosslinked polymeric entity obtained at the end of the first step with one or more hydrophilic entities,
and the extraction of said master molecule from the nanospheres thus formed, for example by washing.

Since the outer surface of the crosslinked entity obtained at the end of the first step has to be converted in order to comprise hydrophilic entities necessary for conferring an amphiphilic behavior on the final structure, the first step should use at least one functionalized hydrophobic monomer.

The expression “functionalized” is meant to denote, for the purposes of the present invention, a monomer containing, in addition to its polymerizable motif(s) used in the synthesis of the crosslinked hydrophobic polymeric entity, at least another functional group not involved in the formation of said hydrophobic entity, and capable of subsequently reacting with a compound different from the monomer to which it is linked.

The term “functionalized” may also be used to denote the hydrophobic polymeric entity resulting from the copolymerization of such monomers, and also having reactive functional groups on its surface.

These functional groups may be of the type comprising all the reactive functional groups conventionally encountered in organic chemistry, such as for example the alcohol, acid, amine, acid halide, alkyl halide, vinyl, anhydride, amide or urethane functional group.

By way of example of functionalized hydrophobic monomers, there may thus be mentioned in particular 1,6-heptadien-4-ol, 1-hexen-3-ol, 1,5-hexadiene-3,4-diol, chloromethylstyrene, bromomethylstyrene, aminoethyl meth(acrylate), hydroxyethyl meth(acrylate) and divinylbenzene.

According to one embodiment of the invention, the hydrophobic polymeric entity is derived from the polymerization of at least one hydrophobic monomer having a log P greater than 0 and at least one cross-linking agent having a log P greater than 0, in the presence of a master molecule having a log P greater than 0.

As regards the second step aimed at conferring an amphiphilic behavior on the crosslinked hydrophobic entity obtained at the end of the first step, it may be performed according to several alternatives.

According to a first alternative, the hydrophobic polymeric entity bearing at least one reactive functional group is exposed to at least one macromolecule of a functionalized hydrophilic nature, in particular formed of at least one linear principal chain, where appropriate crosslinked, bearing at least one of its ends a functional group capable of reacting with at least one functional group of the surface of the crosslinked hydrophobic polymeric entity.

According to this alternative, the conversion according to the second step comprises at least one covalent grafting, in particular by condensation, of at least one macromolecule of a hydrophilic nature functionalized at the surface of the hydrophobic and crosslinked entity derived from the first step. These macromolecules of a hydrophilic nature may be formed of hydrophilic segment(s) in conformity with the definition proposed above for the amphiphilic macromonomers, provided that they are capable, as such, of reacting with the reactive functional group of the surface of the hydrophobic entity or have been functionalized beforehand for this purpose.

Thus, the macromolecules of a hydrophilic nature may be formed of hydrophilic segments of the polyoxyethylene (POE), polysaccharide, polyoxyethylene-polyoxypropylene-polyoxyethylene (POE-PPO-POE), polyoxypropylene-polyoxyethylene polyoxypropylene (PPO-POE-PPO), polyvinyl alcohol, polydioxalane, poly(N-isopropylacrylamide) (poly(NIPAM)), ethyleneimine, polyzwitterion, poly(meth)acrylamide, poly(aminoalkyl(meth)acrylate), polyvinylpyrrolidone, polypropylene glycol, polynucleotide, polypeptide and polyclectrolyte such as polysulfonic, polycarboxylic and polyphosphate type and their hydrophilic copolymers, and additionally containing, at least one of their ends, a functional group capable of reacting with the hydrophobic entity functionalized for example by condensation.

The functional groups capable of reacting with the functionalized polymeric entity are for example all the reactive functional groups conventionally encountered in organic chemistry, such as for example the alcohol, acid, amino, acid halide, anhydride, amide or urethane functional group.

By way of example of a macromolecule of a functionalized hydrophilic nature, there may be mentioned in particular polyethylene glycol amine and polyethylene glycol mercaptan.

According to a second alternative, the hydrophobic entity obtained at the end of the first step is exposed to at least one functionalized hydrophilic monomer.

According to this second variant, the second step additionally comprises at least one polymerization reaction of at least one hydrophilic monomer functionalized at the surface of the hydrophobic and crosslinked polymeric entity obtained at the end of the first step so S as to form hydrophilic segments capable of conferring an amphiphilic behavior on the final star structure.

The hydrophilic monomers suitable for the surface conversion of the hydrophobic core should have a log P of less than 0.

By way of examples of functionalized hydrophilic monomers suitable for carrying out this second variant embodiment, there may be mentioned in particular ethylene oxide, cyclic ethers, lactones, lactams, cyclic amines, cationic, anionic or zwitterionic acrylates, styrene sulfonate, poly(meth)acrylic esters, methacrylamide, acrylamide, 2-acrylamidoglycolic acid, 2-acrylamido-2-methylpropanesulfonic acid, N-acryloxysuccinimide, N-acryloylpyrrolidinone, N-(3-aminopropyl)methacrylamide, N,N′-dimethylacrylamide, 2-methylene-1,3-propanediol, vinyl methyl sulfone, vinylphosphonic acid or the sodium salt of vinylsulfonic acid.

Of course, persons skilled in the art are capable of selecting the compounds suitable for synthesizing the nanospheres according to the invention according to the different variant embodiments described above.

Moreover, any combination of the embodiments described above is considered as a variant embodiment of the present invention.

Regardless of the mode of preparation considered, namely via a single step involving the copolymerization of a hydrophobic monomer with an amphiphilic macromonomer or via two steps according to the process specified above, the formation of the hydrophobic core requires the simultaneous presence of a hydrophobic crosslinking agent and at least one master molecule.

Indeed, the hydrophobic polymeric core is advantageously crosslinked, which allows it in particular to preserve the form of the imprint regardless of the operating conditions. The crosslinking agent should be of a hydrophobic nature, so as to be incorporated into the core of the nanospheres during the polymerization process.

The crosslinking agent suitable for carrying out the present invention has a log P greater than 0, preferably greater than 0.75, or even greater than 1.

By way of crosslinking agents which can be used in the context of the present invention, there may be mentioned in particular divinylbenzene (DVB), 1,3 diisopropenyl-benzene (DIP), ethylene glycol dimethacrylate (EGDMA), tetramethylene dimethacrylate (TDMA), N,O-bisacryloyl-L-phenylalaninol, 1,4-phenylene diacrylamide, N,N′-1,3-phenylenebis(2-methyl-2-propenamide) (PDBMP), 1,4;3,6-dianhydro-D-sorbitol-2,5-dimethacrylate, isopropoylenebis(1,4-phenylene) dimethacrylate, trimnethyolpropane trimethacrylate (TRIM), pentaerythritol triacrylate (PETRA), pentaerythritol tetraacrylate (PETEA), difunctional acrylates, difunctional methacrylates, trifinctional acrylates, trifunctional metbacrylates, tetrafunctional acrylates, tetrafunctional methacrylates, alkylene glycol diacrylates, alkylene glycol methacrylates, diallyldiglycol dicarbonate, diallyl maleate, diallyl fumarate, diallyl itaconate, divinyl oxalate, divinyl malonate, diallyl succinate, bis-phenol A dimethacrylate, bis-phenol A diacrylate, di(alkene)amines, trimethylolpropane triacrylate, divinyl ether, divinyl sulfone and diallyl phthalate.

The crosslinking agent is present in the reaction medium in a proportion ranging from 0.05% to 30% by weight, preferably ranging from 0.10% to 10% by weight.

Master Molecules

As specified above, this polymerization or copolymerization may be performed by free-radical initiation, by polycondensation or by sol-gel in the presence of at least one crosslinking agent and at least one master molecule.

According to a first variant of the invention, the master molecule may be initially present, during the synthesis of the polymeric nanospheres according to the invention, in free form in solution.

According to a second variant of the invention, the master molecule may be initially covalently linked to at least one monomer used for the synthesis of the polymeric nanospheres according to the invention, and may then be released once said polymeric nanospheres have been formed, by breaking said covalent bond.

The covalent bond between said monomer and said master molecule may in particular be a labile bond capable of being broken under the action of temperature, a pH variation, an oxidoreduction reaction, an ultrasound beam or shearing, like for example an ester, disulfide or amide bond.

In other words, it is possible, according to this second variant, to additionally use, for the synthesis of the polymeric nanospheres according to the invention, specific monomers according to the target molecule(s) desired, and in particular monomers derived from a master molecule thus partly acting as monomers intended to form the core of a polymeric nature, and partly acting as a master molecule. In other words, part of these monomers, once the polymerization has been completed, is intended to be removed so as to give rise to the recognition sites.

Subsequently, the molecular recognition may be obtained by covalent and/or noncovalent interactions for the same target molecule. Thus, for a single target molecule, the interaction with the polymeric imprint may be carried out at least at two separate sites of the recognition site as is for example disclosed in Wulff G. et al., Macromol. Chem. Phy. 1989, 190, 1717 and 1727.

According to one embodiment, of the processes for preparing the polymeric nanospheres according to the invention, a nanogel according to the invention and a hydrogel according to the invention, the copolymerization may use at least one monomer linked to the master molecule by at least one covalent bond that is preferably labile.

When the molecule whose imprint it is desired to make is hydrophobic, it is totally soluble in the dispersed fatty phase of the emulsion, and the polymerization reaction described above occurs right around its surface, leading to the imprint of the molecule in its entirety.

On the other hand, if the molecule for which it is desired to make the imprint is amphiphilic, that is to say contains a hydrophilic part and a hydrophobic part, like a surfactant for example, then only the hydrophobic part of the molecule will be present in the dispersed phase, and consequently, the polymerization reaction described above will occur only around the surface of this hydrophobic part, leading to the imprint of only part of the target molecule, or of the master molecule.

The master molecules, corresponding or otherwise to the target molecule, which are suitable for carrying out the present invention advantageously have a log P greater than 0. They may be hydrophobic or amphiphilic.

The molecule whose imprint it is desired to make may moreover be of any size and any molecular mass. It may thus be in particular a molecule having a molecular mass of between 50 and 2000 g/mol, or a macromolecule having a molecular mass which may for example by up to 100 000 g/mol.

It may be chosen in particular from heterocyclic polyaromatics, pesticides, molecules having organoleptic properties such as perfumes and flavorings, food colorings such as carotenoids, riboflavins, tartrazine or amaranth, biologically active molecules having a therapeutic or pharmaceutical character, antioxidant molecules such as polyphenols and flavonoid, colorants such as azo dyes, anthraquinone, polymethine, phthalocyanine.

According to one embodiment of the invention, the target molecule or the master molecule is a biologically active molecule, and in particular having a therapeutic or pharmaceutical character.

As biologically active molecule, there may be mentioned for example hypnotic, anxiolytic, anticancer, muscle-relaxing, diuretic, anti-ulcerative, antiepileptic, antibiotic, anesthetic, analgesic, antihistamine, antihypertensive, antihyperthyroid, anti-inflammatory, antimigraine, antimuscarinic, antiosteoporotic, antiparkinson, antiprotozoal, antipsychotic, antiseptic, antispasmodic, antithrombotic, antitubercular, bronchodilatory, cardiotonic and cholinergic molecules, a central nervous system stimulant, neurotransmitters, contraceptives, an immunomodulator, an immunosuppressant, laxatives, a blocking agent, antiarrhythmics, tocopherols, steroids or sterols.

The target molecule considered according to the present invention may be chosen in particular from polypeptides, hormones, cytokines, enzymes, proteins of any molecular mass such as antibodies, albumin, fibrinogen, fibronectin, insulin or fetoprotein.

According to one embodiment of the invention, the target molecule, or the master molecule, is chosen from polypeptides, hormones, enzymes, cytokines and proteins, and in particular proteins having a molecular mass of less than 65 000 g/mol, and in particular less than 50 000 g/mol, or even less than 5000 g/mol.

According to another embodiment of the invention, the target molecule or the master molecule, has a molecular mass of less than or equal to 2000 g/mol, in particular of less than or equal to 1500 g/mol, or even less than or equal to 1000 g/mol.

The carrying out of the polymerization or polycondensation operations considered according to the invention is clearly within the competence of persons skilled in the art. In particular, the choice of the solvent, the temperature, the pH and the initiation conditions constitute routine operations for persons skilled in the art.

For example, the solvent for the polymerization may be hydrophobic and porogenic, such as for example toluene, benzene, dichloromethane or chloroform, and may be optionally used to form the dispersed phase.

As regards the initiation, it may be carried out according to any process known to a person skilled in the art, and will depend on the polymerization technique selected (free-radical, ionic, by polycondensation, by coordination or by sol-gel).

### APPLICATIONS

The polymeric nanospheres, the nanogels and the hydrogels according to the present invention find application in general in extraction, separation, purification, detection, absorption, adsorption, retention and controlled release.

The nanospheres, the nanogels and the hydrogels according to the invention also find application in particular in the analytical field in the agri-foodstuffs, pharmacy, biomedical, food, defense or environmental sector.

They may also find application in the sensors, such as biosensors, sector, in molecular screening, directed chemical synthesis, sample treatment, combinatorial chemistry, chiral separation, group protection, catalysis, equilibrium shift, polymeric medicaments and encapsulation.

They may also find application in the field of life sciences, by the formation of furtive particles capable of withstanding the nonspecific adsorption of proteins and/or of releasing biologically active molecules or targeting a specific part of the cells or of an organ.

As was mentioned above, the subject of the present invention is also the use of the polymeric nanospheres, the nanogels and the hydrogels according to the invention for the purpose of selective isolation of target molecules sensitive in aqueous media, or in complex biological fluids.

The present invention also relates to the use of the polymeric nanospheres, the nanogels and the hydrogels according to the invention for the purpose of recognizing hydrophobic or amphiphilic target molecules in an organic medium.

The examples below are given by way of illustration and without limiting the invention.

In the examples below, the master molecules are identical to the desired target molecules.

The log P indicated in the examples below were calculated by the software Advanced Chemistry Development (ACD/Labs) V8.14.

### Example 1

### Synthesis of nanospheres according to the invention in the form of a nanogel

Two types of test nanogels are prepared, one using, as master molecule, Boc Tyrosine (log P=2.64), and the other propranolol (log P=3.10), according to the following operating protocol.

In a test tube, 3.00 g of PEG methacrylate (M=2000 g/mol, 50% in water) are diluted in 3.2 g of water to give a transparent solution. 30 mg of trimethylol proprane trimethacrylate (log P=3.15) and 3.2 mg of 3-phenoxy-2-hydroxypropyl acrylate (log P=1.98) are then added, with vigorous stirring, to give a dispersion of said crosslinking agent.

The pH is then adjusted so that the master molecule is the most hydrophobic in water. Thus, the pH is adjusted to 11 in the case of propranolol which is insoluble in water in basic medium, while it is equal to 4 when Boc Tyrosine is used (log P=2.64).

9 mg of the master molecule considered are then added to the test sample, while a control sample consisting of the same reaction medium with the exception of a target molecule is prepared.

After bubbling nitrogen for 10 minutes, 2.2 mg of sodium persulfate are added and then the reaction medium is stirred for a few minutes until a dispersion of the crosslinking agents and of the monomers is obtained. Next, the reaction medium is heated at 60° C. overnight in order to lead to the formation of a homogeneous and cloudy gel.

The gels obtained are then freeze-dried and the size of the nanogels is measured with a nanosizer.

The control nanogel has a mean size of 200 nm while the two test nanogels have a mean size of 80 nm, reflecting the interaction of the target molecule considered with the core of the nanogel.

The target molecule is extracted by washing in an aqueous solution followed by precipitation in cold ethylene glycol.

### Example 2

### Synthesis of nanospheres according to the invention organized in a network so as to form a hydrogel

Two types of test nanogel are prepared using the same target molecules as for Example 1, according to the following operating protocol.

0.15 g of polyethylene glycol PEG, that is 0.105 g of diacrylate 700 and 0.045 g of polyethylene glycol monomethacrylate of molar mass 2000 g/mol, are introduced into a 2 ml bottle so as to give, after mixing, a transparent homogeneous micellar solution in which the micelles measure about 2 nm. 36 mg of trimethylolpropane trimethacrylate are then introduced, leading to the formation of a biphasic system. 15 mg of 2-(dimethylamino)ethyl acrylate (log P =0.95) and 23 mg of 3-phenoxy-2-hydroxypropyl acrylate (log P=1.98) are then added, with vigorous stirring, in order to give a dispersion of the monomers.

The pH is adjusted as described in Example 1, according to the nature of the target molecule used.

30 mg of target molecule are then added to the test sample, while a control sample consisting of the same reaction medium, with the exception of the target molecule, is prepared.

After bubbling nitrogen for 10 minutes, 2.29 mg of sodium persulfate are added and then the reaction medium is stirred for a few minutes until a dispersion of the crosslinking agents and of the monomers is obtained. Next, the reaction medium is heated at 60° C. overnight in order to lead to the formation of a homogeneous and cloudy gel.

The gels are then washed several times with water and then twice using a 5% solution in acetic acid and are finally again rinsed several times with water, allowing the extraction of more than 95% of the target molecule.

### Example 3

### Characterization of the level of adsorption of nanospheres according to the invention.

Test and control gels of Boc Tyrosine are obtained according to a protocol similar to that used in Example 1, using, as monomers, a mixture of 3-phenoxy-2-hydroxypropyl acrylate and carboxyethyl acrylate (log P=0.6). These gels are then subjected to the same steps for extraction of the target molecule as those described in Example 2, so as to extract more than 95% of Boc Tyrosine.

The two gels (test and control) are dried and placed in an aqueous solution of Boc Tyrosine (126 μg/ml). The percentages of Boc Tyrosine adsorbed as a function of time are presented in Table 1 below.

TABLE 1
percentage adsorption of Boc Tyrosine as a function
of time for an initial concentration (126 μg/mL).

| | Control | MIP |
|---|---|---|
| Time (h) | % adsorbed | % adsorbed |
| 0 | 0 | 0 |
| 0.75 | 10.0 | 33.3 |
| 1.5 | 13.3 | 43.2 |
| 2.5 | 15.3 | 45.4 |
| 5 | 22.0 | 53.7 |
| 8.5 | 23.9 | 54.2 |
| 23 | 25.3 | 59.1 |

The test gel adsorbs the target molecule much more strongly and more rapidly than the control gel. The molecular imprinting performed according to the present invention thus exhibits a high affinity for the target molecule while the nonspecific adsorption observed on the control is low.

### Example 4

### Characterization of the release capacity of the nanospheres according to the invention

The samples used in Example 3 are dried and then placed in two aqueous solutions of 2.5 ml, respectively. Samples of these solutions are collected at regular intervals in order to determine the percentage release of Boc Tyrosine expressed in terms of the quantity of Boc Tyrosine adsorbed during the evaluation of the level of adsorption described in Example 3. The percentages of release for the test and control gels are presented in Table 2 below.

TABLE 2
percentage of Boc Tyrosine released as a function of time

| | MIP | Control |
|---|---|---|
| time (h) | % released | % released |
| 0 | 0 | 0 |
| 0.7 | 32.5 | 66.1 |
| 1.5 | 38.7 | 74.5 |
| 3 | 48.0 | 79.1 |
| 5.5 | 53.4 | 91.9 |
| 8 | 53.6 | 95.2 |

The percentage of Boc Tyrosine released is still lower for the test gel than for the control gel, it being possible for the difference to be up to 40%.

Thus, the kinetics of release is slower for the test gel than for the control gel.

### Example 5

### Synthesis of polymeric nanospheres in accordance with the invention according to the method of preparation in two steps

1. First step of formation of the hydrophobic and crosslinked polymeric entity

The synthesis is carried out in a reactor equipped with a stirring device, argon circulation, a thermometer and graduated tubes containing the various purified reagents.

150 ml of THF are first of all introduced into the reactor. The reaction medium is then cooled to −10° C. and then 3.2 g of butyllithium, 10 g of divinylbenzene (log P=3.18), 2 g of ethylstyrene (log P=3.70) and 0.75 g of anthracene (target molecule) are introduced in turn into the reactor, and the polymerization is carried out for 30 minutes at −1020 C.

2. Second step of conversion at the surface of said hydrophobic and crosslinked polymeric entity by a hydrophilic entity

100 g of ethylene oxide are introduced into the reaction medium under a static vacuum at −30° C. The reaction medium is then heated to room temperature and the polymerization is carried out for 48 h at 30° C. The ethylene oxide polymerizes, according to an anionic process, on the reactive sites carried at the surface of the polymeric entity. At the end of the reaction, a few drops of a mixture of methanol and acid are added at 30° C. in order to deactivate the living species. The solution obtained is then filtered on paper, centrifuged and again filtered on paper and then precipitated in heptane or ether.

### Example 6

### Synthesis of a degradable hydrogel whose branches forming the star structure are triblock segments of POE having a central sequence of poly(1,3-dioxolane) (PDXL)

1. Synthesis of PDXL.

PDXL having a weight-average molecular mass of 2000 mol/g was prepared by reacting 2.87 moles of 1,3-DXL with 0.12 mole of Et(OH)₂ and 2.9×10⁻⁴ mole of CF₃SO₃H, under a nitrogen atmosphere according to the following protocol. The 1,3-DXL is first of all introduced and then the triflic acid solution in methylene chloride is added. The temperature increases to 21° C. The reaction mixture is then deactivated by adding a solution comprising 500 mg of sodium in 10 ml of methanol.

After filtration and evaporation of the solvent, the product obtained is dissolved in dichloromethane.

The polymer thus obtained is precipitated in 1.5 L of methanol at −40° C. Its number-average molecular mass is determined by CES and by ¹⁹F NMR.

2. Synthesis of copolymer and macromonomer of POE having a central sequence of PDXL.

10 g of PDXL obtained at the end of the first step are freeze-dried in benzene and then dissolved, under a controlled atmosphere, in 50 ml of THF. The addition of 10 ml of diphenylmethylpotassium, at room temperature, then allows the conversion of the hydroxyl ends of PDXL to alcoholate groups. The reaction medium is then kept stirring for about two hours and then 7.5 g of ethylene oxide are added, and the polymerization of the ethylene oxide initiated by the alcoholates formed during the preceding step begins. The reaction medium then returns to room temperature, and it is then heated at 30° C. for about 48 h.

1 g of methacryloyl chloride is then added in order to functionalize the copolymer thus obtained.

The number-average molecular mass of the copolymer and of the functional macromonomer are 3500, characterized by CES in THF. The rate of double bonds of macromonomers may be determined for its part by UV spectroscopy.

The copolymers thus formed may be used for the synthesis of hydrogels as degradable difunctional macromonomers. Subsequently, degradation by hydrolysis of the PDXL fragments of said hydrogels can lead to the formation of nanogels.

### Example 7

### Synthesis of nanospheres on a larger scale according to the invention in the form of a nanogel and their purifications

Test nanogels are prepared using, as master molecule, Boc phenylalanine anilide (log P=4.4) according to the following operating protocol.

367 mg of master molecule are mixed with 355 mg of methacrylic acid (log P=0.83) and 2.66 g of ethylene glycol dimethacrylate (log P=2.78), 22 g of PEG methacrylate (M=2000 g/mol, 50% in water) are added to this solution in order to form a cloudy solution which is stirred with 100 g of water. The solution, whose pH is of the order of 4, is introduced into a 200 ml jacketed reactor regulated at 60° C. The stirring is produced by a turbine at a speed of 1000 rpm.

A control solution is prepared in the same manner in the absence of master molecules.

After bubbling nitrogen for 20 minutes, the stirring is continued for 30 minutes until a uniformly cloudy solution is obtained. The addition of 360 mg of V50 initiates the polymerization reaction which lasts overnight. A uniformly cloudy and stable solution, more viscous than the initial solution, is obtained.

The solution of nanogel is purified by dialysis in aqueous medium with regenerated cellulose having a cut-off of 6000-8000.

The size of the nanogels obtained is measured with a nanosizer.

The control nanogel consists of particles of which 65% have a mean size of 600 nm and 35% have a mean size of 35 nm. The test nanogel consists of particles of which 30% have a mean size of 300 nm and 70% have a mean size of 30 nm, demonstrating the interaction of the target molecule considered with the core of the nanogel.

The nanogel solution is then freeze-dried to give a white powder.

For the extraction of the master molecule, the powder is dispersed in a volume of acetonitrile and then precipitated in ten volumes of ether cooled at −40° C. The precipitated polymer is isolated by filtration. This operation is repeated until no extractible master molecules remain.

Analysis of the rate of adsorption obtained by separation of the bound target molecules from the freed target molecules by filtration through a membrane (cut-off 5000) during centrifugation confirms the high affinity of the imprint prepared for the target molecule.

1-34. (canceled)

35. A crosslinked polymeric nanosphere having a star-shaped structure of the core-branch type, in which the branches are of a hydrophilic nature and the core is of a polymeric, crosslinked, hydrophobic nature and forms the imprint of all or at least part of a target molecule.

36. The nanosphere as claimed in claim 35, in which the imprint is that of a hydrophobic or amphiphilic molecule.

37. The nanosphere as claimed in claim 35, in which the branches are covalently linked to the core.

38. The nanosphere as claimed in claim 35, in which the branches of a hydrophilic nature comprise hydrophilic segments chosen from segments of the polyoxyethylene (POE), polysaccharide, polyoxyethylene-polyoxypropylene-polyoxyethylene (POE-PPO-POE), polyoxypropylene-polyoxyethylene-polyoxypropylene (PPO-POE-PPO), polyvinyl alcohol, polydioxalane, poly(N-isopropylacrylamide) (poly(NIPAM)), polyethyleneimine, polyzwitterion, poly(meth)acrylamide, poly(aminoalkyl(meth)acrylate), polyvinylpyrrolidone, polypropylene glycol, polynucleotide, polypeptide and polyelectrolyte such as polysulfonic, polycarboxylic and polyphosphate type and their hydrophilic copolymers.

39. The nanosphere as claimed in claim 35, in which the branches are formed by the hydrophilic segment of at least one amphiphilic macromonomer and the core is derived from the copolymerization of the hydrophobic polymerizable motif of said amphiphilic macromonomer with at least one hydrophobic monomer, in the presence of at least one hydrophobic crosslinking agent and at least one master molecule.

40. The nanosphere as claimed in claim 39, in which at least one amphiphilic macromonomer has a single hydrophobic motif capable of copolymerizing.

41. The nanosphere as claimed in claim 39, in which at least one amphiphilic macromonomer has at least two hydrophobic motifs capable of copolymerizing.

42. The nanosphere as claimed in claim 39, in which the hydrophobic motif capable of copolymerizing is chosen from vinyl, acrylic, methacrylic, allyl, styrene motifs or any other unsaturated motif capable of reacting by the free-radical route, and the chemical groups allowing a polycondensation or sol-gel reaction.

43. The nanosphere as claimed in claim 40, in which said macromonomer is chosen from polyethylene glycol ethyl ether methacrylate, polyethylene glycol (meth)acrylate, polyethylene glycol methyl ether-block-polylactide, polyethylene glycol alkyl ether (meth)acrylate, polyethylene glycol aryl ether (meth)acrylate, polyethylene glycol vinylbenzene, block copolymers containing a hydrophilic segment and a polymerizable hydrophobic motif such as polyacrylic acid-block-polystyryl styrene, polyacrylamide-block-polystyryl styrene, polysaccharide-block-polymethacryloyl (meth)acrylate.

44. The nanosphere as claimed in claim 41, in which said macromonomer is chosen from polyethylene glycol di(meth)acrylate, polyethylene glycol divinylbenzene, or triblock polymers consisting of a hydrophilic central block (for example based on polyethylene glycol, polyacrylic acid, polyacrylamide, poly(vinylpyrrolidone), or polysaccharide and of a hydrophobic block modified by a polymerizable functional group at each end (for example of the polystyryl styrene or polymethacryloyl (meth)acrylate type).

45. The nanosphere as claimed in claim 39, in which the hydrophobic monomer is chosen from acrylic, methacrylic, acrylamide, styrene, vinyl and allyl monomers, and chemical groups allowing a polycondensation or sol-gel reaction.

46. The polymeric nanospheres as claimed in claim 45, in which the hydrophobic monomer is chosen from methyl methacrylate, styrene, ethylstyrene, methacrylic acid, alkyl methacrylates, alkyl acrylates, allyl acrylates, allyl methacrylates, aryl acrylates, aryl methacrylates, styrene derivatives, vinyl acetate, acrylonitrile, methacrylonitrile, 2-aminoethyl methacrylate, t-amyl methacrylate, 2-(1-aziridinyl)ethyl methacrylate, t-butylacrylamide, butyl acrylate, butyl methacrylate, 4-vinylpyridine, 2-vinylpyridine, 2-vinylquinoline, dimethylaminoethyl acrylate, 3-phenoxy-2-hydroxypropyl acrylate and 2-carboxyethyl methacrylate.

47. The nanosphere as claimed in claim 39, characterized in that the amphiphilic macromonomer is a polyethylene glycol methacrylate and the hydrophobic monomer is of the (meth)acrylate type.

48. The nanosphere as claimed in claim 35, in which the target molecule, or the master molecule, has a molecular mass of less than or equal to 2000 g/mol.

49. The nanosphere as claimed in claim 35, in which the target molecule, or the master molecule, is a biologically active molecule.

50. The nanosphere as claimed in claim 49, in which the target molecule, or the master molecule, is chosen from polypeptides, hormones, enzymes, cytokines and proteins.

51. A nanogel, that is in the form of a dispersion of polymeric nanospheres having a star-shaped structure of the core-branch type, in which the branches are of a hydrophilic nature and the core is of a polymeric, crosslinked, hydrophobic nature and forms the imprint of all or at least part of a target molecule.

52. The nanogel as claimed in claim 51, wherein the polymeric nanospheres are in dispersion in water.

53. A hydrogel, that is in the form of a network of polymeric nanospheres having a star-shaped structure of the core-branch type, in which the branches are of a hydrophilic nature and the core is of a polymeric, crosslinked, hydrophobic nature and forms the imprint of all or at least part of a target molecule.

54. The hydrogel as claimed in claim 53, characterized in that the hydrophobic polymeric cores of the polymeric nanospheres have crosslinking nodes of said hydrogel.

55. A process for preparing polymeric nanospheres having a star-shaped structure of the core-branch type, in which the branches are of a hydrophilic nature and the core is of a polymeric, crosslinked, hydrophobic nature and forms the imprint of all or at least part of a target molecule, by copolymerization of at least one amphiphilic macromonomer with at least one hydrophobic monomer in the presence of at least one hydrophobic crosslinking agent and at least one master molecule, followed by the extraction of said master molecule from said polymeric nanospheres.

56. A process for preparing a nanogel that is in the form of a dispersion of polymeric nanospheres having a star-shaped structure of the core-branch type, in which the branches are of a hydrophilic nature and the core is of a polymeric, crosslinked, hydrophobic nature and forms the imprint of all or at least part of a target molecule, comprising at least the copolymerization of at least one amphiphilic macromonomer comprising a single hydrophobic motif capable of copolymerizing with at least one hydrophobic monomer in the presence of at least one hydrophobic crosslinking agent and at least one master molecule, and the extraction of said master molecule from said polymeric nanospheres.

57. A process for preparing a hydrogel that is in the form of a dispersion of polymeric nanospheres having a star-shaped structure of the core-branch type, in which the branches are of a hydrophilic nature and the core is of a polymeric, crosslinked, hydrophobic nature and forms the imprint of all or at least part of a target molecule, comprising at least the copolymerization of at least one amphiphilic macromonomer comprising at least two hydrophobic motifs capable of copolymerizing with at least one hydrophobic monomer in the presence of at least one hydrophobic crosslinking agent and at least one master molecule, and the extraction of said master molecule from said polymeric nanospheres.

58. The process as claimed in claim 55, in which the hydrophobic monomer is chosen from acrylic, methacrylic, acrylamide, styrene, vinyl and allyl monomers, and chemical groups allowing a polycondensation or sol-gel reaction and the amphiphilic macromonomer has a single hydrophobic motif capable of copolymerizing or at least two hydrophobic motifs capable of copolymerizing.

59. The process as claimed in claim 56, in which the hydrophobic monomer is chosen from acrylic, methacrylic, acrylamide, styrene, vinyl and allyl monomers, and chemical groups allowing a polycondensation or sol-gel reaction and the amphiphilic macromonomer has a single hydrophobic motif capable of copolymerizing or at least two hydrophobic motifs capable of copolymerizing.

60. The process as claimed in claim 57, in which the hydrophobic monomer is chosen from acrylic, methacrylic, acrylamide, styrene, vinyl and allyl monomers, and chemical groups allowing a polycondensation or sol-gel reaction and the amphiphilic macromonomer has a single hydrophobic motif capable of copolymerizing or at least two hydrophobic motifs capable of copolymerizing.

61. A process for preparing polymeric nanospheres having a star-shaped structure of the core-branch type, in which the branches are of a hydrophilic nature and the core is of a polymeric, crosslinked, hydrophobic nature and forms the imprint of all or at least part of a target molecule, comprising:
a first step of copolymerizing at least one functionalized hydrophobic monomer in the presence of at least one hydrophobic crosslinking agent, at least one master molecule, and optionally at least one hydrophobic monomer.
a second step of converting, at the surface, the hydrophobic and crosslinked polymeric entity obtained at the end of the first step with one or more hydrophilic entities, and extracting said master molecule from said polymeric nanospheres.

62. The process as claimed in claim 61, in which the second step comprises at least a covalent grafting of at least one macromolecule of a functionalized hydrophilic nature, at the surface of said hydrophobic and crosslinked polymeric entity.

63. The process as claimed in claim 61, in which the second step comprises at least one polymerization reaction of at least one functionalized hydrophilic monomer at the surface of said hydrophobic polymeric entity.

64. The process as claimed in claim 63, in which the functionalized hydrophilic monomer is chosen from ethylene oxide, cyclic ethers, lactones, lactams, cyclic amines, cationic, anionic or zwitterionic acrylates, styrene sulfonate, poly(meth)acrylic esters, methacrylamide, acrylamide, 2-acrylamidoglycolic acid, 2-acrylamido-2-methylpropanesulfonic acid, N-acryloxysuccinimide, N-acryloylpyrrolidinone, N-(3-aminopropyl)methacrylamide, N,N′-dimethylacrylamide, 2-methylene-1,3 propanediol, vinyl methyl sulfone, vinylphosphonic acid or the sodium salt of vinylsulfonic acid.

65. The process as claimed in claim 60, in which the functionalized hydrophobic monomer is chosen from 1,6-heptadien-4-ol, 1-hexen-3-ol, 1,5-hexadiene-3,4-diol, chloromethylstyrene, bromomethylstyrene, aminoethyl meth(acrylate), hydroxyethyl meth(acrylate) and divinylbenzene.

66. The process as claimed in claim 55, in which the copolymerization uses at least one monomer linked to the master molecule by at least one covalent bond.

67. The process as claimed in claim 56, in which the copolymerization uses at least one monomer linked to the master molecule by at least one covalent bond.

68. The process as claimed in claim 57, in which the copolymerization uses at least one monomer linked to the master molecule by at least one covalent bond.

69. The process as claimed in claim 60, in which the copolymerization uses at least one monomer linked to the master molecule by at least one covalent bond.

70. A polymeric nanosphere having a star-shaped structure of the core-branch type, in which the branches are of a hydrophilic nature and the core is of a polymeric, crosslinked, hydrophobic nature and forms the imprint of all or at least part of a target molecule, useful for extraction, detection, separation, purification, absorption, adsorption, retention or controlled release or in applications chosen from sensors, catalysis of chemical reactions, screening of molecules, directed chemical synthesis, treatment of samples, combinatory chemistry, chiral separation, group protection, displacement of equilibrium, polymeric medicaments and encapsulation.

71. A nanogel in the form of a dispersion of polymeric nanospheres having a star-shaped structure of the core-branch type, in which the branches are of a hydrophilic nature and the core is of a polymeric, crosslinked, hydrophobic nature and forms the imprint of all or at least part of a target molecule, useful for extraction, detection, separation, purification, absorption, adsorption, retention or controlled release or in applications chosen from sensors, catalysis of chemical reactions, screening of molecules, directed chemical synthesis, treatment of samples, combinatory chemistry, chiral separation, group protection, displacement of equilibrium, polymeric medicaments and encapsulation.

72. A hydrogel in the form of a network of polymeric nanospheres having a star-shaped structure of the core-branch type, in which the branches are of a hydrophilic nature and the core is of a polymeric, crosslinked, hydrophobic nature and forms the imprint of all or at least part of a target molecule, useful for extraction, detection, separation, purification, absorption, adsorption, retention or controlled release or in applications chosen from sensors, catalysis of chemical reactions, screening of molecules, directed chemical synthesis, treatment of samples, combinatory chemistry, chiral separation, group protection, displacement of equilibrium, polymeric medicaments and encapsulation.

73. A method of selective isolation of sensitive target molecules in aqueous media or in complex biological fluids, using polymeric nanospheres having a star-shaped structure of the core-branch type, in which the branches are of a hydrophilic nature and the core is of a polymeric, crosslinked, hydrophobic nature and forms the imprint of all or at least part of a target molecule or a nanogel in the form of a dispersion of polymeric nanospheres having a star-shaped structure of the core-branch type, in which the branches are of a hydrophilic nature and the core is of a polymeric, crosslinked, hydrophobic nature and forms the imprint of all or at least part of a target molecule, or a hydrogel in the form of a network of polymeric nanospheres having a star-shaped structure of the core-branch type, in which the branches are of a hydrophilic nature and the core is of a polymeric, crosslinked, hydrophobic nature and forms the imprint of all or at least part of a target molecule.

74. A method of recognition and extraction of hydrophobic or amphiphilic target molecules in organic medium, using the polymeric nanosphere having a star-shaped structure of the core-branch type, in which the branches are of a hydrophilic nature and the core is of a polymeric, crosslinked, hydrophobic nature and forms the imprint of all or at least part of a target molecule, or a nanogel in the form of a dispersion of polymeric nanospheres having a star-shaped structure of the core-branch type, in which the branches are of a hydrophilic nature and the core is of a polymeric, crosslinked, hydrophobic nature and forms the imprint of all or at least part of a target molecule, or a hydrogel in the form of a network of polymeric nanospheres having a star-shaped structure of the core-branch type, in which the branches are of a hydrophilic nature and the core is of a polymeric, crosslinked, hydrophobic nature and forms the imprint of all or at least part of a target molecule.
